(19) United States
(12) Patent Application Publication
(10) Pub. No.: US 2022/0108556 A1
(43) Pub. Date: Apr. 7, 2022

(54) METHOD OF COMPARING DOCUMENTS, ELECTRONIC DEVICE AND READABLE STORAGE MEDIUM

(71) Applicant: Beijing Baidu Netcom Science Technology Co., Ltd., Beijing (CN)

(72) Inventors: Yiyu PENG, Beijing (CN); Teng HU, Beijing (CN); Hua LU, Beijing (CN); Yongfeng CHEN, Beijing (CN)

(21) Appl. No.: 17/552,149

(22) Filed: Dec. 15, 2021

(30) Foreign Application Priority Data
Dec. 15, 2020 (CN) 202011477927.6

(51) Int. Cl. G06V 30/418; G06V 30/412; G06V 30/10; G06F 40/103; G06F 16/93

(52) U.S. Cl. CPC G06V 30/418; G06V 30/412; G06F 16/93; G06F 40/103; G06V 30/10

(57) ABSTRACT

A method of comparing documents, an electronic device, and a readable storage medium are provided, which relate to the field of data processing technology, and specifically to the field of big data technology. In the present disclosure, an area division is performed on each document of two documents to be compared, according to a document layout of each document, so as to obtain at least two sets of comparison units. Each set of comparison units comprises comparison units for the two documents respectively and the comparison units for the two documents correspond to each other. Thus, a content comparison may be performed on between comparison units of each of the at least two sets, so as to obtain a content comparison result for each set of comparison units as a comparison result for the two documents.

### CROSS-REFERENCE TO RELATED APPLICATIONS

This application is claims priority to Chinese Application No. 202011477927.6, filed on Dec. 15, 2020, which is incorporated herein by reference in its entirety.

### TECHNICAL FIELD

The present disclosure relates to a field of data processing technology, specifically to a field of big data technology, and in particular to a method of comparing documents, an electronic device, and a readable storage medium.

### BACKGROUND

Contracts, papers, templates, etc. may have multiple versions of documents, for example. When comparing content of different versions of documents, a related comparison algorithm is based on text lines. Generally, text lines of two documents to be compared are acquired through document parsing, and then are sorted from left to right and from top to bottom, in order to form a set of sentences, forming a string by splicing. Then comparison is performed character by character. In this way, an accuracy of comparing documents is low.

### SUMMARY

According to an aspect of the present disclosure, a method of comparing documents is provided, including:

performing an area division on each document of two documents to be compared, according to a document layout of said each document, so as to obtain at least two sets of comparison units, wherein each set of comparison units comprises comparison units for the two documents respectively and the comparison units for the two documents correspond to each other, wherein the document layout includes at least one of a layout identification, a layout content, or a layout location;

performing a content comparison on between comparison units of each of the at least two sets, so as to obtain a content comparison result for each set of comparison units; and

obtaining a comparison result for the two documents, according to the content comparison result for each set of comparison units.

According to yet another aspect of the present disclosure, an electronic device is provided, including:

at least one processor; and

a memory communicatively connected to the at least one processor,

the memory stores instructions executable by the at least one processor, and the instructions, when executed by the at least one processor, cause the at least one processor to implement the method of the aspect and any possible implementation as described above.

According to yet another aspect of the present disclosure, there is provided a non-transitory computer-readable storage medium having computer instructions stored thereon, the computer instructions are configured to cause a computer to implement the method of the aspect and any possible implementation as described above.

It should be understood that the content described in this section is not intended to identify the critical or important features of the embodiments of the present disclosure, nor is it intended to limit the scope of the present disclosure. Other features of the present disclosure will be easily understood through the following description.

### BRIEF DESCRIPTION OF THE DRAWINGS

In order to more clearly explain the technical solutions in the embodiments of the present disclosure, the following will briefly introduce the drawings that need to be used in the description of the embodiments or the prior art. It may be noted that the drawings in the following description are some of the embodiments of the present disclosure, for those of ordinary skill in the art, other drawings may be obtained based on these drawings without creative labor. The accompanying drawings are only used to better understand the present disclosure, and do not constitute a limitation to the present disclosure, in which:

FIG. 1 is a schematic diagram of the method of comparing documents according to an embodiment of the present disclosure;

FIG. 2 is a schematic diagram of a document layout of a document to be compared in the embodiment corresponding to FIG. 1;

FIG. 3 is a schematic diagram of a document alignment technology adopted in the embodiment corresponding to FIG. 1;

FIG. 4 is a schematic diagram of the method of comparing documents according to another embodiment of the present disclosure; and

FIG. 5 is a schematic diagram of an electronic device used to implement the method of comparing documents of the embodiments of the present disclosure.

### DETAILED DESCRIPTION OF EMBODIMENTS

The following describes exemplary embodiments of the present disclosure with reference to the accompanying drawings, which include various details of the embodiments of the present disclosure to facilitate understanding, and should be regarded as merely exemplary. Therefore, those of ordinary skill in the art should recognize that various changes and corrections may be made to the embodiments described herein without departing from the scope and spirit of the present disclosure. Likewise, for clarity and conciseness, descriptions of well-known functions and structures are omitted in the following description.

It may be noted that the described embodiments are part of the embodiments of the present disclosure, but not all of the embodiments. Based on the embodiments in the present disclosure, all other embodiments obtained by those of ordinary skill in the art without creative work shall fall within the protection scope of the present disclosure.

It should be noted that terminal devices involved in the embodiments of the present disclosure may include, but are not limited to, mobile phones, personal digital assistants (PDA), wireless handheld devices, tablet computers and other smart devices; display devices may include, but are not limited to, devices with display functions such as personal computers and televisions.

In addition, the term “and/or” in this description is only an association relationship describing associated objects, which means that there may be three kinds of relationships. For example, A and/or B may represent A alone, both A and B, and B alone. In addition, the character “/” in this description generally indicates that the associated objects are in an “or” relationship.

With a rapid advancement of Internet technology and a rapid popularization of computers, it is more and more common to use electronic documents (hereinafter referred to as documents) to replace paper publications in work and life.

In daily office activities, it often needs to perform content comparison on content of different versions of documents. For example, contracts, papers, templates, etc. may have multiple versions of documents. If manual comparison is used, then it will consume a lot of manpower, the efficiency is low, and the comparison time period is long. Besides, due to a huge workload, it tends to omit or make mistakes in the comparison process.

Generally, comparison algorithms may improve the efficiency of comparison. However, comparison algorithms are based on text lines. Specifically, text lines of two documents to be compared are acquired through document parsing, and then are sorted from left to right and from top to bottom, in order to form a set of sentences, forming a string by splicing. Then comparison is performed character by character. In this way, an accuracy of comparing documents is still low.

According to embodiments of the present disclosure, a method of comparing documents, an electronic device, and a readable storage medium, in order to recognize duplicate data, thereby improving the reliability and validity of data.

The present disclosure proposes a method of comparing documents, in which corresponding sets of comparison units are obtained by segmenting the document content based on the document layout, and then separate content comparison is performed on each set of comparison units. Therefore, in the process of comparison, a mutual influence between the contents of the comparison units of each set is eliminated, and the accuracy of comparing documents is finally improved.

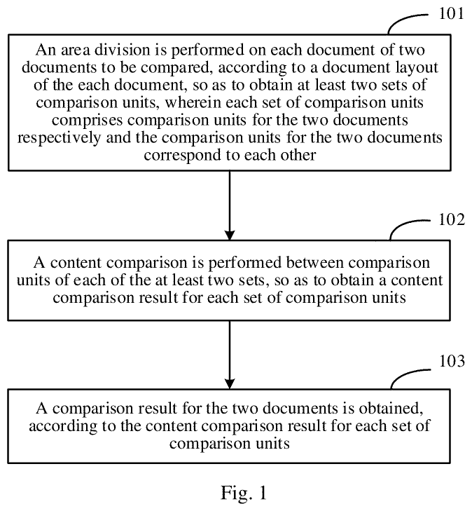

FIG. 1 is a schematic diagram according to a first embodiment of the present disclosure, as shown in FIG. 1.

In operation 101, an area division is performed on each document of two documents to be compared, according to a document layout of the each document, so as to obtain at least two sets of comparison units, wherein each set of comparison units comprises comparison units for the two documents respectively and the comparison units for the two documents correspond to each other.

The document layout may include but is not limited to at least one of a layout identification, a layout content, or a layout location. This is not particularly limited in the embodiment.

In operation 102, a content comparison is performed between comparison units of each of the at least two sets, so as to obtain a content comparison result for each set of comparison units.

In operation 103, a comparison result for the two documents is obtained according to the content comparison result for each set of comparison units.

According to the embodiments of the present disclosure, an area division is performed on each document of two documents to be compared, according to a document layout of said each document, so as to obtain at least two sets of comparison units, in which each set of comparison units comprises comparison units for the two documents respectively and the comparison units for the two documents correspond to each other. Thus, a content comparison may be performed between comparison units of each of the at least two sets, so as to obtain a content comparison result for each set of comparison units as a comparison result for the two documents. The area division based on the document layout is performed on each document to be compared, multiple sets of comparison units, which are for the two documents respectively and correspond to each other, are obtained, and content comparison is performed separately on the various sets of comparison units obtained for different areas. Therefore, the accuracy of comparing documents is improved effectively, thereby improving the user experience.

The documents in the present disclosure refer to text and picture materials that use chemical magnetic physical materials such as computer disks, solid state drives, magnetic disks, and optical disks as carriers. It mainly includes electronic documents such as electronic files electronic letters, electronic reports, electronic drawings, and electronic versions of paper text documents.

It should be noted that operations 101-103 may be performed partly or totally by an application located in a local terminal, or other functional units, such as a plug-in or a software development kit (SDK) provided in the application located in the local terminal, or a processing engine located in a server on the network side, or a distributed system located on a network side, for example, a processing engine or a distributed system in a document comparison server on the network side. The embodiment does not specifically limit to this.

It may be understood that the application may be a local application (nativeApp) installed on the local terminal, or may also be a webpage program (webApp) of a browser on the local terminal, which is not limited in the embodiment.

In this way, the corresponding sets of comparison units are obtained by segmenting the document content based on the document layout, and then the content comparison is separately performed on each set of comparison units. Therefore, in the process of comparison, the mutual influence between the content of each set of comparison units is eliminated, and the accuracy of comparing documents is finally improved.

In the present disclosure, the document layout may include but is not limited to at least one of the layout identification, the layout content, or the layout location. This is not particularly limited in the embodiment.

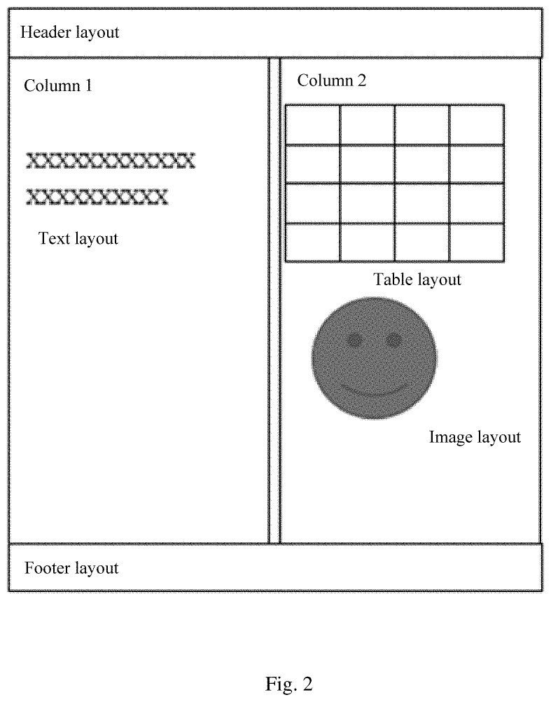

The layout content refers to a specific form of the document layout, The layout content may include but is not limited to at least one of a text layout, an image layout, a table layout, a column layout, a header layout, or a footer layout. Specifically, as shown in FIG. 2, the text layout refers to a layout of the document content in form of text. The image layout refers to a layout of the document content in form of image. The table layout refers to a layout of the document content in form of table. The column layout refers to a layout of the document content in form of column(s) such as a single-column content, a double-column content, or a triple-column content. FIG. 2 shows a column layout of double-column content, which specifically including column 1 and column 2. The header layout refers to a layout of the document content in form of header. The footer layout refers to a layout of the document content in form of footer.

The layout identification refers to identification information of the specific form of the document layout, that is, identification information of the layout content. In order to facilitate the identification of the layout content, types of the above-mentioned layout content may also be identified in a form of numbers or letters, for example, identification information of the header layout is set to 01, identification information of the footer layout is set to 02, identification information of the body layout is set to 03 and so on.

The layout location refers to a document location where the specific form of the document layout is located, for example, a location having a distance of 0.8 cm from the bottom line of a page. Generally, various layout contents of a document have a relatively fixed layout location. By recognizing the layout location, various document layouts of the document may be recognized. For example, the layout location is a location that a distance between the location and the bottom line of the page is 0.8 cm and a distance between the location and the left line of the page is equal to a distance between the location and the right line of the page. Then, it is possible to recognize that a document layout of a document corresponding to the location is the footer layout, according to the layout location.

In practical applications, in some cases, for example, the content of the document is in various forms, or the document may have more than one page of content, and there may be multiple pages of content. The documents that need content comparison often contain two or more layout content, such as the header layout, the footer layout and the body layout (for example, the header layout, the footer layout and the body layout such as the text layout, the table layout, the image layout, etc.). Related comparison methods lack of reliable segmentation ideas, such that the layout content of different document layouts are not distinguished effectively when performing content comparison. In the process of content comparison, it tends to cause confusion in the content to be compared, that is, comparing uncorresponding parts of the two documents to be compared, resulting in an incorrect comparison result. For example, comparing the content of the header part or footer part in one of the documents to be compared with the content of the body part in the other one of the documents to be compared generates an incorrect comparison result finally. Therefore, the accuracy rate of the comparison result is greatly reduced.

The present disclosure provides a completely different method for comparing document content, that is, firstly, the content of two documents to be compared is segmented according to the document layout to form different comparison units. For example, a document may be divided such that a header part of the document may be divided into a comparison unit, a footer part of the document may be divided into a comparison unit, and a body part of the document may be divided into a comparison unit. As another example, the body part may be further divided such that an image part in the body part is divided into a comparison unit, a table part in the body part is divided into a comparison unit, and a text part in the body part is divided into a comparison unit.

After the above segmentation process is completed, the content comparison may be performed between the corresponding comparison units of the two documents to be compared.

For example, the content comparison may be performed between the comparison unit of the header part of one of the two documents to be compared and the comparison unit of the header part of the other one of the two documents to be compared, so as to obtain a comparison result for the set of comparison units of the header parts. For the content comparison on the footer parts and the content comparison on the body parts, corresponding comparison results may be obtained in the same way.

After comparison of the contents of all corresponding comparison units of the two documents to be compared are completed, the content comparison results of various sets of comparison units are summarized to obtain the content comparison result for the two documents to be compared above.

In this way, the corresponding sets of comparison units are obtained by segmenting the document content based on the document layout, and then the content comparison is separately performed on each set of comparison units. Therefore, in the process of comparison, the mutual influence between the contents of comparison units of each set is eliminated, and the accuracy of comparing documents is finally improved.

Optionally, in a possible implementation of the embodiment, before operation 101, a document format of each document of the two documents to be compared may be determined, and a format conversion may be performed on a document having a format different from a specified format, so as to obtain a document having the specified format as a document to be compared.

The document format of the document to be compared in the present disclosure may be any of PDF format, doc format, docx format, xls format, xlsx format, htm format, or html format, which is not specially limited in the embodiment.

A Portable Document Format (PDF) file is a computer file type that has been established as an industry standard file type, and allows documents to be created and saved for use in many different practical applications. A function of using the portable document format file is independent from computer hardware or software applications, that is, PDF documents are universal whether they are in Windows operating systems, Unix operating systems, or Apple's Mac OS operating systems.

Based on the versatility of PDF documents, the layout format of PDF documents may not change in different computer operating systems. Therefore, PDF documents may be used as a standard format in the disclosure. That is, the two documents to be compared are both converted into PDF format documents, and then the operations 101 to 103 are performed for the content comparison. In addition, in this manner, the present disclosure may be adapted to any computer operating system.

In this way, by converting the two documents to be compared into PDF documents with the same typesetting format, the implementation method may be made more versatile, and at the same time, adverse effects of format change to the process of comparison may be avoided. This will help improve the accuracy of the comparison result.

Optionally, in a possible implementation of the embodiment, in operation 101, specifically, a feature analysis may be performed on each document according to the document layout of each document, so as to obtain at least one feature segment of each document. Then, a document alignment may be performed according to each of the least one feature segment. Then, the at least two sets of comparison units corresponding to each other for the two document respectively may be obtained according to a result of the document alignment. In the embodiments of the present disclosure, document alignment technology is employed, thereby the accuracy of comparing documents may further be improved, and a complexity of comparing documents may be reduced.

In this implementation, the document alignment technology is used to divide the comparison units. That is, at least one unique feature segment is acquired from each of the two documents to be compared, and a correspondence between the feature segments of the two documents to be compared is established according to respective feature segments. Then the feature segments having the correspondence are used to segment the content of the two documents to be compared, so as to obtain the at least two sets of comparison units corresponding to each other for the documents. The above comparison units are obtained by using document alignment technology, which ensures that there is an accurate correspondence between the comparison units, avoids the confusion of the correspondence between each set of comparison units, and thus helps to improve the accuracy rate of the comparison.

The feature segments here are able to accurately identify the document content of the document, and able to distinguish the identified part of the document from other parts of the document. Optionally, the separation of the feature segments is able to be implemented in a relatively simple manner, so as to improve the execution efficiency of the process.

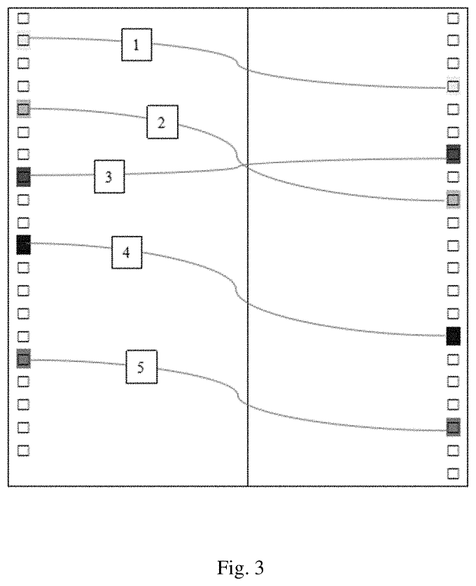

As shown in FIG. 3, after obtaining feature segments of document 1 to be compared and feature segments of document 2 to be compared, specifically, a correspondence between the feature segments of the two documents may be established based on these feature segments. As shown by the curves in FIG. 3: there is a one-to-one correspondence between a feature segment of the document 1 to be compared and a feature segment of the document 2 to be compared, which are corresponding to two ends of the curve respectively. Curve 2 and curve 3 are staggered, which means that locations of feature segments corresponding to two ends of the two curves intersect. In view of this, for the content of the two documents to be compared, the corresponding feature segments of the two documents are different in location order. For the feature segments corresponding to curve 2 and curve 3 which intersect in order, the reason for the intersection is likely that the location of the feature segment 2 or feature segment 3 has been moved during a content adjustment process. Therefore, feature segments that are not suitable for alignment basis may be deleted from the feature segments. Other feature segments with one-to-one correspondence in the content of the two documents to be compared are used as anchor points, and the two documents to be compared are divided into the same number of comparison units, thus forming sets of comparison units.

In a specific implementation each document may be divided into at least one content segment according to the document layout of each document. The feature analysis may be performed on each of the at least one content segment, so as to obtain the at least one feature segment of each document.

Specifically, after obtaining at least one content segment divided by each document, a feature analysis method is adopted to perform feature analysis on each content segment. If results of the feature analysis of a corresponding content segment are consistent, the content segment may be regarded as a feature segment of the document.

For example, in the process of feature analysis, a feature analysis method based on an N-gram model may be used. The N-Gram is an algorithm based on a statistical language model. A basic idea of the N-gram is to perform a sliding window operation of size N on a content of a text according to bytes, thereby forming a sequence of byte segments of length N. Each byte segment is called a Gram segment. Occurrence frequencies of all Gram segments are counted and filtered according to a preset threshold, so as to form a key Gram list, that is, a vector feature space of this text. Each kind of Gram segment in the list is a feature vector dimension. The larger the value of N is, the stronger the resolving ability is. Here, in order to ensure that the recognition is sufficiently accurate, the value of N is preferably greater than 8. If two Gram segments are consistent, the Gram segments may be used as a feature segment of the respective documents.

In this way, by performing feature analysis on at least one content segment in each document, at least one feature segment is obtained. The above method is simple to implement and has high efficiency. In this implementation, at least one content segment may be selected from the two document contents to be compared, and the feature analysis may be performed on the content segment in the same way. If the results of the feature analysis of the two content segments are consistent, the content segment may be used as a feature segment.

Optionally, in a possible implementation of the embodiment, for a case where characters in an image need to be recognized in the document, in operation 101, a character recognition may be performed on an image in each document, by using a pre-trained optical character recognition OCR model, so as to obtain an image recognition character in the image.

In this implementation, for a PDF document in an image version, or an image containing characters in a document to be compared, if the content is compared according to an existing method based on character comparison, the characters in the image needs to be recognized compared through the OCR model.

In this implementation, the process of using the OCR model to perform the character recognition on the image in the document may generally include but is not limited to: an image input step, a pre-processing step including binarization, noise removal, and pre-tilt correction, a layout analysis step for dividing the document image into paragraphs and lines, a character segmenting step, a character recognition step, a layout restoration step, and a post-processing and checking step. Existing OCR model recognition technology still has a technical problem of low recognition efficiency.

For this reason, based on the existing OCR model, this implementation further uses crawler technology to acquire relevant training data according to an application scenario (including background information such as a technical field, a class, etc.) of a train document of an application scenario to which the two documents to be compared belong, and converts the training data into an image. Then, some enhancement methods (for example, blur, distortion, lighting changes, watermark/stamp, etc.) are used to acquire a large number of labeled training data, and these labeled training data are used to tune and train the existing OCR model to obtain an improved OCR model.

Then, the present disclosure may use the improved OCR model to perform the character recognition on the image in the document. The improved OCR model may be obtained by training using the train document of the application scenario (for example, an application scenario of a contract document) to which the two documents to be compared belong, so as to perform the character recognition on the image in each document in the present disclosure.

In this way, a higher recognition accuracy may be obtained by using the pre-trained improved OCR model to recognize the characters in the image in the document, thereby improving the accuracy of document content comparison.

Optionally, in a possible implementation of the embodiment, in operation 102, the content comparison result for each set of comparison units may be corrected. The comparison result for the two documents may be obtained according to the corrected content comparison result for each set of comparison units. In the embodiments of the present disclosure, a content comparison result for each set of comparison units is corrected, thereby the accuracy of comparing documents may further be improved.

In the content comparison process or in any part before the content comparison process, there is a possibility of errors. Once an error occurs, it will cause the content comparison result for the comparison units to be incorrect. In the present disclosure, in order to reduce the probability of errors in the content comparison result for each set of comparison units, the correction may be performed on the content comparison result for each set of comparison units. After correction, the content comparison results are summarized as the comparison result for the two documents, which effectively improves the accuracy of the document content comparison.

In a specific implementation, in the correction, at least one difference content of each set of comparison units for which the content comparison result is a difference comparison result and a location of each difference content of the at least one difference content may be obtained. A difference type (such as body content difference, header content difference, etc.) of each difference content may be determined according to the obtained difference content(s) of each set of comparison units and the location of the difference content(s). If the difference type of a difference content is a specific type, then a difference comparison result corresponding to the difference content may be ignored.

In this implementation, the specific type of difference may be a difference in the content of a special layout except the body layout, such as a difference in the header content or a difference in the footer content.

Failing to recognize a content, which is not a body content, corresponding to layout content such as the header layout or the footer layout may lead to an incorrect difference comparison result, so that such difference result should be ignored. A cluster analysis is performed by combining the difference content and the location of the difference content, so that the difference type of the difference content is determined. Then, the difference type of the difference content is determined. If the difference type of the difference content belongs to the specific type, it indicates that the result for the above comparison is an invalid result. Thus, this type of comparison result may be ignored. Through the above method, the incorrect difference comparison result is ignored, which helps to further improve the accuracy of comparing documents.

In another specific implementation, in the correction, at least one difference content of each set of comparison units for which the content comparison result is a difference comparison result is obtained. In case that the difference content of each set of comparison units obtained has a specified number of characters and is recognized based on the OCR model, a similarity recognition may be performed on images to which the difference content having the specified number of characters belongs, by using an image similarity model, so as to determine whether the images to which the difference content having the specified number of characters belongs are consistent. If the images to which the difference content having the specified number of characters belongs are consistent, a difference comparison result corresponding to the difference content having the specified number of characters may be ignored.

For characters or character combination of a specified number of characters having complex styles, such as a single word, a single letter, etc., the existing OCR model inevitably has recognition errors when recognizing characters, which makes the difference content of the document contents displayed in a final content comparison result may be incorrect. In this case, in order to improve the accuracy of comparing documents, a second comparison may be performed on the difference content of the specified number of characters displayed in the content comparison result.

Specifically, the second comparison may be performed on the difference content of the specified number of characters existing in the content comparison result by image comparison, and it is determined whether the two contents are identical by determining a similarity between images to which the two contents belong.

A single word or a single letter is taken as an example. In view of a limited number of common Chinese and English characters, for a single-character image or a single-letter image with complex patterns that are prone to recognition errors, a corresponding single-character image or a single-letter image may be generated through data enhancement methods, such as glyph, lighting, deformation, etc. The image similarity model may be trained by using a Pointwise method or a Pairwise method, and then the image similarity model is used to perform the similarity recognition on the single-character difference or the single-letter difference in the content comparison result, so as to determine whether there is a difference between the two contents. If it is determined that there is a difference between the two contents after the similarity recognition, then there is no need to perform any operation on the difference comparison result corresponding to the difference content of the single character or single letter, that is, no correction is needed. If it is determined that there is no difference between the two contents after the similarity recognition, it means that the difference content is caused by an recognition error of the OCR model, then the difference comparison result corresponding to the difference content of the single character or single letter may be ignored, thereby ultimately improving the accuracy of comparing documents.

An object of Pointwise processing is a single document. After the document is converted into a feature vector, a sorting problem is transformed into a conventional classification or regression problem in machine learning. Pairwise is currently a more popular method. As compared with Pointwise, Pairwise focuses on a document order relationship, and mainly reduces the sorting problem to a binary classification problem.

The technical solution of the present disclosure has the following advantages:

1. Features in multiple pages of content are analyzed, which helps to obtain a global document layout. The multi-page content of the document is divided into areas according to the global document layout, so that at least two sets of comparison units corresponding to each other between the multi-page content of each document, that is, a correct comparison content stream, may be obtained. Therefore, when comparing complex multi-page documents, the complexity of the comparison is reduced, and the confusion that is prone to appear in the comparison process of various complex documents (especially long documents, complex layout documents, etc.) is greatly reduced. Thus, the accuracy of comparing documents is improved.

2. By using the document alignment technology, at least one unique feature segment is acquired from the content of the two documents to be compared respectively, a correspondence between the feature segments of the two documents to be compared is established based on each feature segment, and the content of the two documents to be compared is divided by the feature segments with the correspondence. In this way, at least two sets of comparison units corresponding to each other between the documents are obtained. The above comparison units are obtained using the document alignment technology, which ensures that there is an accurate correspondence between the comparison units, avoids the confusion of the correspondence between each set of comparison units, and reduces situations where the compared contents do not correspond to each other during the comparison process of the two documents to be compared, which helps to improve the accuracy of the comparison.

3. The existing OCR model inevitably has recognition errors when recognizing single characters or single letters with complex styles. Therefore, if the difference content in the comparison result is a single character or a single letter recognized by the OCR model, then the technical solution provided by the present disclosure may be adopted. The image similarity model is used to perform similarity recognition on the single-character or single-letter images of the above-mentioned difference content to determine whether the images of the difference content of the specified number of characters are consistent. Furthermore, the above-mentioned comparison result is corrected, the incorrect comparison result caused by the recognition error of the OCR model is recognized, and the corresponding following steps are taken, thereby helping to improve the accuracy of comparing documents.

In the embodiment, an area division is performed on each document of two documents to be compared, according to a document layout of each document, so as to obtain at least two sets of comparison units corresponding to each other for the two documents. Thus, a content comparison may be performed on each set of comparison units in the at least two sets of comparison units, so as to obtain a content comparison result for said each set of comparison units as a comparison result for the two documents. The area division based on the document layout is performed on each document to be compared, multiple sets of comparison units corresponding to each other between each document are obtained, and a corresponding content comparison is performed separately on each set of comparison units of different areas obtained. Therefore, the accuracy of comparing documents is improved effectively.

It should be noted that for the sake of simple description, the foregoing method embodiments are all expressed as a series of action combinations, but those skilled in the art should know that the present disclosure is not limited to the described sequence of actions. According to the present disclosure, certain steps may be performed in other order or simultaneously. Furthermore, those skilled in the art should also know understand the embodiments described in the specification are all optional embodiments, and the actions and modules involved are not necessarily required by the present disclosure.

In the above-mentioned embodiments, the description of each embodiment has its own emphasis. For parts that are not described in detail in an embodiment, please refer to related descriptions of other embodiments.

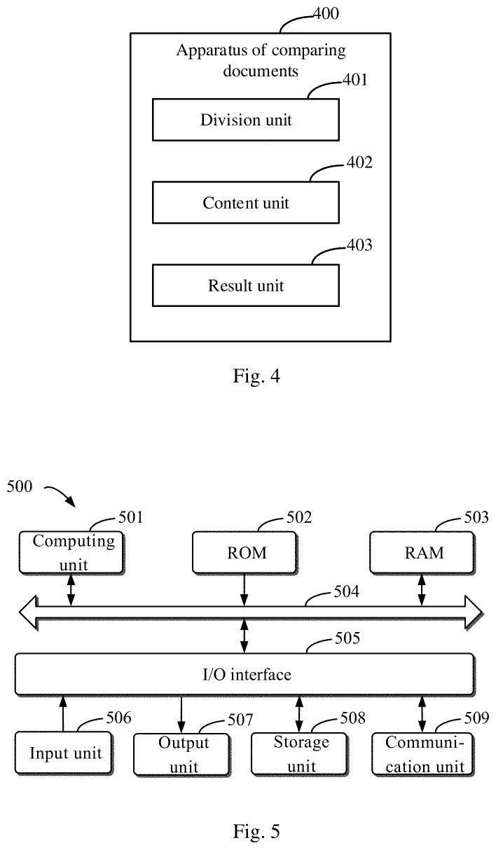

FIG. 4 is a schematic diagram according to a second embodiment of the present disclosure, as shown in FIG. 4. The apparatus 400 of comparing documents of the embodiment may include a division unit 401, a content unit 402, and a result unit 403. The dividing unit 401 is used to perform an area division on each document of two documents to be compared, according to a document layout of said each document, so as to obtain at least two sets of comparison units corresponding to each other for the two documents. Each set of comparison units comprises comparison units for the two documents respectively and the comparison units for the two documents correspond to each other. The document layout includes at least one of a layout identification, a layout content and a layout location. The content unit 402 is used to perform a content comparison between comparison units of each of the at least two sets, so as to obtain a content comparison result for each set of comparison units. The result unit 403 is used to obtain a comparison result for the two documents, according to the content comparison result for each set of comparison units.

It should be noted that part or all of the apparatus of comparing documents in the embodiment may be an application located in a local terminal, or may also be other functional units, such as a plug-in or a software development kit (SDK) provided in the application located in the local terminal, or it may also be a processing engine located in a server on the network side, or may also be a distributed system located on a network side, for example, a processing engine or a distributed system in a document comparison server on the network side. The embodiment does not specifically limit to this.

It may be understood that the application may be a local application (nativeApp) installed on the local terminal, or may also be a webpage program (webApp) of a browser on the local terminal, which is not limited in the embodiment.

In this way, the division unit performs an area division on each document of two documents to be compared, according to a document layout of said each document, so as to obtain at least two sets of comparison units corresponding to each other for the two documents. Thus, the content unit may perform a content comparison on each set of comparison units in the at least two sets of comparison units, so that the result unit may obtain a content comparison result for said each set of comparison units as a comparison result for the two documents. In the embodiment, the area division based on the document layout is performed on each document to be compared, multiple sets of comparison units corresponding to each other between each document are obtained, and a corresponding content comparison is performed separately on each set of comparison units of different areas obtained. Therefore, the accuracy of comparing documents is improved effectively.

Optionally, in a possible implementation of the embodiment, the division unit 401 is further used to determine a document format of each document of the two documents to be compared; and perform a format conversion on a document having a format different from a specified format, so as to obtain a document having the specified format as a document to be compared.

In this way, the division unit converts the two documents to be compared into PDF documents with unchangeable typesetting and format, making the implementation more versatile while avoiding adverse effects of format change to the process of comparison. This will help improve the accuracy of the comparison result.

Optionally, in a possible implementation of the embodiment, the division unit 401 is specifically used to perform a feature analysis on each document, according to the document layout of each document, so as to obtain at least one feature segment of each document; perform a document alignment, according to each of the least one feature segment; and obtain the at least two sets of comparison units according to a result of the document alignment.

In this implementation, the division unit uses the document alignment technology to divide the comparison units. That is, the division unit acquires at least one unique feature segment from the document content of each of the two documents to be compared, and a correspondence between the feature segments of the two documents to be compared is established according to the feature segment. Then the feature segments having the correspondence are used to segment the contents of the two documents to be compared, so as to obtain the at least two sets of comparison units corresponding to each other between the documents. The above comparison units are obtained by using document alignment technology, which ensures that there is an accurate correspondence between the comparison units, avoids the confusion of the correspondence between each set of comparison units, and thus helps to improve the accuracy rate of the comparison.

In a specific implementation, the division unit 401 is specifically used to divide each document into at least one content segment according to the document layout of each document; and perform the feature analysis on each of the at least one content segment, so as to obtain the at least one feature segment of each document.

Specifically, after obtaining at least one content segment divided from each document, the division unit 401 adopts a feature analysis method to perform feature analysis on each content segment. If results of the feature analysis of a corresponding content segment are consistent, the content segment may be regarded as a feature segment of the document.

In this way, the division unit performs feature analysis on at least one content segment in each document, so that at least one feature segment is obtained. The above method is simple to implement and has high efficiency. In this implementation, the division unit selects at least one content segment from the two document contents to be compared, and the feature analysis may be performed on the content segment in the same way. If the results of the feature analysis of the two content segments are consistent, the content segment may be used as a feature segment.

Optionally, in a possible implementation of the embodiment, the division unit 401 is further used to perform a character recognition on an image in each document, by using a pre-trained optical character recognition OCR model, so as to obtain an image recognition character in the image, the OCR model is trained by using a train document of an application scenario to which the two documents to be compared belongs.

In this implementation, for a PDF document in an image version, or an image containing texts in a document to be compared, if the content comparison is to be performed on the image according to an existing method based on character comparison, the content in the image may be recognized as characters through the OCR model before comparison.

OCR is an abbreviation of Optical Character Recognition, which refers to a technology of analyzing and recognizing image files containing text data to obtain text and layout information. The process of using the OCR model to process an image may generally include: an image input step, a pre-processing step including binarization, noise removal, and pre-tilt correction, a layout analysis step for dividing the document image into paragraphs and lines, a character segmenting step, a character recognition step, a layout restoration step, and a post-processing and checking step. Existing OCR model recognition technology still has a technical problem of low recognition efficiency.

For this reason, before performing the character recognition on the image in each document based on the existing OCR model, the division unit further uses crawler technology to acquire relevant training data according to an application scenario (including background information such as a technical field, a class, etc.) of a train document of an application scenario to which the two documents to be compared belong, and converts the training data into a picture. Then, some enhancement methods (for example, blur, distortion, lighting changes, watermark/stamp, etc.) are used to acquire a large number of labeled training data, and these labeled training data are used to tune and train the existing OCR model to obtain an improved OCR model in the present disclosure. A higher recognition accuracy may be obtained by using the pre-trained improved OCR model to recognize the characters in the image in the document by the division unit, thereby improving the accuracy of document content comparison.

Optionally, in a possible implementation of the embodiment, the result unit 403 may be specifically used to correct the content comparison result for each set of comparison units; and obtain the comparison result for the two documents according to the corrected content comparison result for each set of comparison units.

In the content comparison process or in any part before the content comparison process, there is a possibility of errors. Once an error occurs, it will cause the content comparison result for the comparison units to be incorrect. In the embodiment, in order to reduce the probability of errors in the content comparison result for each set of comparison units, the correction may be performed on the content comparison result for each set of comparison units by the result unit. After the correction, the content comparison results are summarized as the comparison result for the two documents, which effectively improves the accuracy of the document content comparison.

In a specific implementation, the result unit 403 may be specifically used to obtain at least one difference content of each set of comparison units for which the content comparison result is a difference comparison result, and a location of each difference content of the at least one difference content; determine a difference type of each difference content, according to the obtained at least one difference content of each set of comparison units and the location of each difference content of the at least one difference content; and ignore a difference comparison result corresponding to a difference content in response to the difference type of the difference content being a specified type.

Specifically, in this implementation, the specified type of difference may be a difference in the content of a special layout except the body layout, such as a difference in the header content or a difference in the footer content. Failing to recognize a content, which is not a body content, corresponding to layout content such as the header layout or the footer layout may lead to an incorrect difference comparison result, so that such difference result should be ignored. A cluster analysis is performed by acquiring the difference content and the location of the difference content by the result unit, so that the difference type of the difference content is determined. Then, the result unit is used to determine the difference type of the difference content. If the difference type of the difference content belongs to the specific type, it indicates that the result for the above comparison is an invalid result. Thus, this type of comparison result may be ignored. Through the above method, the incorrect difference comparison result is ignored, which helps to further improve the accuracy of comparing documents.

In another specific implementation, the result unit 403 may be specifically used to obtain at least one difference content of each set of comparison units for which the content comparison result is a difference comparison result; and in response to the difference content of each set of comparison units obtained has a specified number of characters and the difference content having a specified number of characters is recognized based on the OCR model, perform a similarity recognition on images to which the difference content having the specified number of characters belongs, by using an image similarity model, so as to determine whether the images to which the difference content having the specified number of characters belongs are consistent; and ignore a difference comparison result corresponding to the difference content having the specified number of characters, in response to the images to which the difference content having the specified number of characters belongs being consistent.

For characters or character combination of a specified number of characters having complex styles, such as a single word, a single letter, etc., the existing OCR model inevitably has recognition errors when recognizing characters, such that the difference content of the document contents displayed in a final content comparison result may be incorrect. In this case, in order to improve the accuracy of comparing documents, the result unit may be used to perform a second comparison on the difference content of the specified number of characters displayed in the content comparison result.

Specifically, the result unit may be used to perform the second comparison on the difference content of the specified number of characters existing in the content comparison result by image comparison, and it is determined whether the two contents are the identical by determining a similarity between images containing the two contents respectively.

A single character or a single letter is taken as an example. In view of a limited number of common Chinese and English characters, for a single-character image or a single-letter image with complex patterns that are prone to recognition errors, a corresponding single-character image or a single-letter image may be generated through data enhancement methods. The image similarity model may be trained by using a Pointwise method or a Pairwise method, and then the image similarity model is used to perform the similarity recognition on the single-character difference or the single-letter difference in the content comparison result, so as to determine whether there is a difference between the two contents or the difference is resulted from an recognition error of the OCT module. If it is determined that there is a difference between the two contents, then the difference comparison result corresponding to the difference content of the single character or single letter may be ignored, thereby ultimately improving the accuracy of comparing documents.

It should be noted that the method in the embodiment corresponding to FIG. 1 may be implemented by the apparatus of comparing documents provided in this embodiment. For detailed description, please refer to the relevant content in the embodiment corresponding to FIG. 1, which will not be repeated here.

In this way, the division unit performs an area division on each document of two documents to be compared, according to a document layout of said each document, so as to obtain at least two sets of comparison units corresponding to each other for the two documents. Thus, the content unit may perform a content comparison on each set of comparison units in the at least two sets of comparison units, so as to obtain a content comparison result for said each set of comparison units. The result unit sets the content comparison result for said each set of comparison units as a comparison result for the two documents. The area division based on the document layout is performed on each document to be compared, multiple sets of comparison units corresponding to each other between each document are obtained, and a corresponding content comparison is performed separately on each set of comparison units of different areas obtained. Therefore, the accuracy of comparing documents is improved effectively.

Collecting, storing, using, processing, transmitting, providing, and disclosing etc. of the personal information of the user involved in the present disclosure all comply with the relevant laws and regulations, and do not violate the public order and morals.

According to the embodiments of the present disclosure, the present disclosure further provides an electronic device, a readable storage medium, and a computer program product.

FIG. 5 shows a schematic block diagram of an exemplary electronic device 500 for implementing the embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 5, the electronic device 500 includes a computing unit 501, which may perform various appropriate actions and processing based on a computer program stored in a read-only memory (ROM) 502 or a computer program loaded from a storage unit 508 into a random access memory (RAM) 503. Various programs and data required for the operation of the electronic device 500 may be stored in the RAM 503. The computing unit 501, the ROM 502 and the RAM 503 are connected to each other through a bus 504. An input/output (I/O) interface 505 is also connected to the bus 504.

Various components in the electronic device 500, including an input unit 506 such as a keyboard, a mouse, etc., an output unit 507 such as various types of displays, speakers, etc., a storage unit 508 such as a magnetic disk, an optical disk, etc., and a communication unit 509 such as a network card, a modem, a wireless communication transceiver, etc., are connected to the I/O interface 505. The communication unit 509 allows the electronic device 500 to exchange information/data with other devices through a computer network such as the Internet and/or various telecommunication networks.

The computing unit 501 may be various general-purpose and/or special-purpose processing components with processing and computing capabilities. Some examples of the computing unit 501 include but are not limited to a central processing unit (CPU), a graphics processing unit (GPU), various dedicated artificial intelligence (AI) computing chips, various computing units running machine learning model algorithms, a digital signal processor (DSP), and any appropriate processor, controller, microcontroller, and so on. The computing unit 501 may perform the various methods and processes described above, such as the method of comparing documents. For example, in some embodiments, the method of comparing documents may be implemented as a computer software program that is tangibly contained on a machine-readable medium, such as the storage unit 508. In some embodiments, part or all of a computer program may be loaded and/or installed on electronic device 500 via the ROM 502 and/or the communication unit 509. When the computer program is loaded into the RAM 503 and executed by the computing unit 501, one or more steps of the method of comparing documents described above may be performed. Alternatively, in other embodiments, the computing unit 501 may be configured to perform the method of comparing documents in any other appropriate way (for example, by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from the storage system, the at least one input device and the at least one output device, and may transmit the data and instructions to the storage system, the at least one input device, and the at least one output device.

Program codes for implementing the method of the present disclosure may be written in any combination of one or more programming languages. These program codes may be provided to a processor or a controller of a general-purpose computer, a special-purpose computer, or other programmable data processing devices, so that when the program codes are executed by the processor or the controller, the functions/operations specified in the flowchart and/or block diagram may be implemented. The program codes may be executed completely on the machine, partly on the machine, partly on the machine and partly on the remote machine as an independent software package, or completely on the remote machine or the server.

In the context of the present disclosure, the machine readable medium may be a tangible medium that may contain or store programs for use by or in combination with an instruction execution system, device or apparatus. The machine readable medium may be a machine-readable signal medium or a machine-readable storage medium. The machine readable medium may include, but not be limited to, electronic, magnetic, optical, electromagnetic, infrared or semiconductor systems, devices or apparatuses, or any suitable combination of the above. More specific examples of the machine readable storage medium may include electrical connections based on one or more wires, portable computer disks, hard disks, random access memory (RAM), read-only memory (ROM), erasable programmable read-only memory (EPROM or flash memory), optical fiber, convenient compact disk read-only memory (CD-ROM), optical storage device, magnetic storage device, or any suitable combination of the above.

In order to provide interaction with users, the systems and techniques described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with users. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), Internet, and blockchain network.

The computer system may include a client and a server. The client and the server are generally far away from each other and usually interact through a communication network. The relationship between the client and the server is generated through computer programs running on the corresponding computers and having a client-server relationship with each other. The server may be a cloud server, also known as a cloud computing server or a cloud host. The cloud server is a host product in the cloud computing service system to solve the shortcomings of difficult management and weak business scalability in the traditional physical host and VPS (Virtual Private Server) service. The server may also be a server of a distributed system, or a server combined with a blockchain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of comparing documents, comprising:
performing an area division on each document of two documents to be compared, according to a document layout of said each document, so as to obtain at least two sets of comparison units, wherein each set of comparison units comprises comparison units for the two documents respectively and the comparison units for the two documents correspond to each other, wherein the document layout comprises at least one of a layout identification, a layout content, or a layout location;
performing a content comparison between comparison units of each of the at least two sets, so as to obtain a content comparison result for each set of comparison units; and
obtaining a comparison result for the two documents, according to the content comparison result for each set of comparison units.

2. The method of claim 1, wherein before the performing an area division on each document of two documents to be compared, according to a document layout of said each document, so as to obtain at least two sets of comparison units, the method further comprising:
determining a document format of said each document of the two documents to be compared; and
performing a format conversion on a document having a format different from a specified format, so as to obtain a document having the specified format as a document to be compared.

3. The method of claim 1, wherein the performing an area division on each document of two documents to be compared, according to a document layout of said each document, so as to obtain at least two sets of comparison units, comprising:
performing a feature analysis on said each document according to the document layout of said each document, so as to obtain at least one feature segment of said each document;
performing a document alignment according to each of the least one feature segment; and
obtaining the at least two sets of comparison units according to a result of the document alignment.

4. The method of claim 3, wherein the performing a feature analysis on said each document according to the document layout of said each document, so as to obtain at least one feature segment of said each document, comprising:
dividing said each document into at least one content segment according to the document layout of said each document; and
performing the feature analysis on each of the at least one content segment, so as to obtain the at least one feature segment of said each document.

5. The method of claim 1, wherein the performing an area division on each document of two documents to be compared, according to a document layout of said each document, so as to obtain at least two sets of comparison units, further comprising:
performing a character recognition on an image in said each document, by using a pre-trained optical character recognition OCR model, so as to obtain an image recognition character in the image, wherein the OCR model is trained by using a train document of an application scenario to which the two documents to be compared belong.

6. The method of claim 1, wherein the obtaining a comparison result for the two documents according to the content comparison result for each set of comparison units, comprising:
correcting the content comparison result for each set of comparison units; and
obtaining the comparison result for the two documents according to the corrected content comparison result for each set of comparison units.

7. The method of claim 2, wherein the obtaining a comparison result for the two documents according to the content comparison result for each set of comparison units, comprising:
correcting the content comparison result for each set of comparison units; and
obtaining the comparison result for the two documents according to the corrected content comparison result for each set of comparison units.

8. The method of claim 3, wherein the obtaining a comparison result for the two documents according to the content comparison result for each set of comparison units, comprising:
correcting the content comparison result for each set of comparison units; and
obtaining the comparison result for the two documents according to the corrected content comparison result for each set of comparison units.

9. The method of claim 4, wherein the obtaining a comparison result for the two documents according to the content comparison result for each set of comparison units, comprising:
correcting the content comparison result for each set of comparison units; and
obtaining the comparison result for the two documents according to the corrected content comparison result for each set of comparison units.

10. The method of claim 5, wherein the obtaining a comparison result for the two documents according to the content comparison result for each set of comparison units, comprising:
correcting the content comparison result for each set of comparison units; and
obtaining the comparison result for the two documents according to the corrected content comparison result for each set of comparison units.

11. The method of claim 6, wherein the correcting the content comparison result for each set of comparison units, comprising:
obtaining at least one difference content of each set of comparison units for which the content comparison result is a difference comparison result, and a location of each difference content of the at least one difference content;
determining a difference type of each difference content, according to the obtained at least one difference content of each set of comparison units and the location of each difference content of the at least one difference content; and
ignoring a difference comparison result corresponding to a difference content, in response to the difference type of the difference content being a specified type.

12. The method of claim 6, wherein the correcting the content comparison result for each set of comparison units, comprising:
obtaining at least one difference content of each set of comparison units for which the content comparison result is a difference comparison result;
in response to the difference content of each set of comparison units obtained has a specified number of characters and the difference content having a specified number of characters is recognized based on the OCR model, performing a similarity recognition on images to which the difference content having the specified number of characters belongs, by using an image similarity model, so as to determine whether the images to which the difference content having the specified number of characters belongs are consistent; and
ignoring a difference comparison result corresponding to the difference content having the specified number of characters, in response to the images to which the difference content having the specified number of characters belongs being consistent.

13. The method of claim 2, wherein the performing an area division on each document of two documents to be compared, according to a document layout of said each document, so as to obtain at least two sets of comparison units, comprising:
performing a feature analysis on said each document according to the document layout of said each document, so as to obtain at least one feature segment of said each document;
performing a document alignment according to each of the least one feature segment; and
obtaining the at least two sets of comparison units according to a result of the document alignment.

14. The method of claim 13, wherein the performing a feature analysis on said each document according to the document layout of said each document, so as to obtain at least one feature segment of said each document, comprising:
dividing said each document into at least one content segment according to the document layout of said each document; and
performing the feature analysis on each of the at least one content segment, so as to obtain the at least one feature segment of said each document.

15. The method of claim 2, wherein the performing an area division on each document of two documents to be compared, according to a document layout of said each document, so as to obtain at least two sets of comparison units, further comprising:
performing a character recognition on an image in said each document, by using a pre-trained optical character recognition OCR model, so as to obtain an image recognition character in the image, wherein the OCR model is trained by using a train document of an application scenario to which the two documents to be compared belong.

16. An electronic device, comprising:
at least one processor; and
a memory communicatively connected to the at least one processor,
wherein the memory stores instructions executable by the at least one processor, and the instructions, when executed by the at least one processor, cause the at least one processor to implement the method of claim 1.

17. The electronic device of claim 16, wherein the at least one processor is further configured to: before performing an area division on each document of two documents to be compared, according to a document layout of said each document, so as to obtain at least two sets of comparison units,
determine a document format of said each document of the two documents to be compared; and
perform a format conversion on a document having a format different from a specified format, so as to obtain a document having the specified format as a document to be compared.

18. The electronic device of claim 16, wherein the at least one processor is further configured to:
perform a feature analysis on said each document according to the document layout of said each document, so as to obtain at least one feature segment of said each document;
perform a document alignment according to each of the least one feature segment; and
obtain the at least two sets of comparison units according to a result of the document alignment.

19. A non-transitory computer-readable storage medium having computer instructions stored thereon, wherein the computer instructions are configured to cause a computer to implement the method of claim 1.

20. The non-transitory computer-readable storage medium of claim 19, wherein the computer instructions are further configured to cause a computer to: before performing an area division on each document of two documents to be compared, according to a document layout of said each document, so as to obtain at least two sets of comparison units, determine a document format of said each document of the two documents to be compared; and
perform a format conversion on a document having a format different from a specified format, so as to obtain a document having the specified format as a document to be compared.
